(19) United States
(12) Patent Application Publication
(10) Pub. No.: US 2012/0329625 A1
(43) Pub. Date: Dec. 27, 2012

(54) METHOD OF FABRICATING A SELF-RIGHTING CORE FITNESS BALL AND CORE FITNESS BALL

(76) Inventors: Ian Coats MacColl, Mill Valley, CA (US); Alden Morris Mills, Kentfield, CA (US)

(21) Appl. No.: 13/331,563

(22) Filed: Dec. 20, 2011

Related U.S. Application Data
(60) Provisional application No. 61/425,011, filed on Dec. 20, 2010.

(51) Int. Cl. A63B 26/00; B23P 17/04; A63B 45/00

(52) U.S. Cl. 482/142; 29/527.1; 29/530

(57) ABSTRACT

A core fitness ball includes an inflatable ball and a metal bung within the interior of the ball. The ball further includes a target on an outer surface thereof which designates body positioning information for the user.

### PRIORITY STATEMENT

The present application claims the benefit under 35 U.S.C. §119(e) of U.S. Provisional Patent Application Ser. No. 61/425,011 to MacColl et al., filed Dec. 20, 2010 and entitled “EXERCISE BALL WITH WEIGHTED BASE”, the entire contents of which is hereby incorporated by reference herein.

### BACKGROUND

1. Field

Example embodiments in general are directed to a method of fabricating a self-righting core fitness exercise ball and to a core fitness ball.

2. Related Art

In order to develop the abdominal or core muscle regions of the body, exercisers have turned to the use of core fitness exercise balls. Typically obtainable in 55 cm, 65 cm or 75 cm diameter sizes, core fitness balls require the user to flex and exert core body muscles to maintain balance on or against the ball. The core fitness ball thus creates instability during an exercise routine, requiring the user to exercise his or her core muscles, particularly those in the abdominal region, in order to maintain balance during to overcome the instability. Accordingly, core fitness or “stability” balls are known to develop balance and stability by exercising the core body muscles.

An issue with these core fitness balls is that the balls tend to move or roll relative to an underlying support surface. While it is desirable for the core fitness ball to create instability in the exerciser, it is not desirable for the ball to randomly move or roll relative to the support surface. For example, a stability ball that is instable with respect to the support surface tends to roll out of position unless the user is continuously in contact with it. A user can become occupied with maintaining the position of the ball, thus detracting from the core body training experience.

Moreover, none of these core fitness or stability balls includes means that ensures that body positioning is always in the correct location on the ball so that the exerciser can maximize the effect of the exercise to the core or abdominal muscles, as well as to prevent repeated roll-off of their body from the ball.

Some conventional core fitness balls have incorporated the use of a sand filler within the ball to add weight, and hence stability to the core ball. However, the filler moves around within the ball's interior, thus the ball does not always self-right immediately, or self-right in the same location as the filler spreads during movement.

### SUMMARY

An example embodiment is directed to a method of fabricating a self-righting core fitness ball. In the method, a product ball design is created in software for a mold. Upper and lower semi-circular mold halves are formed based on the created product design. Forming the lower mold half further includes forming a larger metal stanchion protruding inward for creating an interior channel in the to-be-formed ball and forming a smaller metal stanchion protruding inward and offset from the larger metal stanchion for creating an aperture for a fill valve in the to-be-formed ball. A cylindrical member is placed over the formed larger stanchion in preparation for forming a ledge within the interior channel. The upper and lower mold halves are mounted on a rotational molding machine, and plastic material is forced into the mold halves to form the ball, the ball having an opening exposing the interior channel with ledge therein. A weighted bung is formed and inserted into the interior channel via the opening.

Another example embodiment is directed to a core fitness ball which includes an expandable, inflatable ball composed of burst-resistant material, an opening provided in the ball, with the opening including an interior channel protruding inward into the ball interior, and a weighted bung inserted into the interior channel via the opening. The ball includes a target on an outer, upper surface area thereof designating body positioning information for a user on the ball.

Another example embodiment is directed to a core fitness ball which includes an expandable, inflatable ball, an opening provided at a base of the ball contacting a surface, and a weighted bung inserted through the opening into the interior of the ball which is secured within upon insertion.

Another example embodiment is directed to a core fitness ball which includes an inflatable ball and a metal bung within the interior of the ball. The ball further includes a target on an outer surface thereof which designates body positioning information for the user.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a perspective view of an exercise ball with weighted base in accordance with an example embodiment.

FIG. 2 is a profile view of the ball of FIG. 1 to show relative location of air fill and bung locations in more detail.

FIG. 3 is a bottom view of the ball of FIG. 1.

FIG. 4 a profile view of the ball of FIG. 1 to show location of a circular area on the ball to place graphics indicating where to place body position.

FIG. 5 is a perspective view of a weighted bung coated in a vinyl material in accordance with an example embodiment.

FIG. 6 is a transparent partial sectional view of a weighted bung inserted into a formed interior column within the ball in accordance with an example embodiment.

FIG. 7 is a bottom view showing complete installation of the bung within the ball.

FIG. 8 is an example air fill channel with associated air valve in accordance with the example embodiments.

FIG. 9 is a diagram to illustrate an example graphic for body positioning on the ball, according to an example embodiment.

FIG. 10 illustrates a user positioning their body on the ball according to the graphic of FIG. 9.

FIG. 11 is a flow diagram for illustrating a method of fabricating a self-righting core fitness ball according to an example embodiment.

FIG. 12 is a flow diagram illustrating process design steps in creating a product design according to the method of FIG. 11.

FIG. 13 is a flow diagram illustrating the forcing of plastic materials step of FIG. 11 in more detail.

FIG. 14 illustrates the formed mold halves of the fabrication process.

FIG. 15 is a close-up view of the lower mold half used in the fabrication process to show design aspects of the ball in more detail.

FIG. 16 is a close-up view of the lower mold half used in the fabrication process to show design aspects of the interior channel and ledge in more detail.

### DETAILED DESCRIPTION

The example embodiments hereafter describe a method of making a core fitness ball and a core fitness ball which removes the guesswork out of fitness ball exercises. As described in more detail hereafter, the combination of a self-righting ball with body positioning technology may help achieve optimal body positioning with maximum muscle activation.

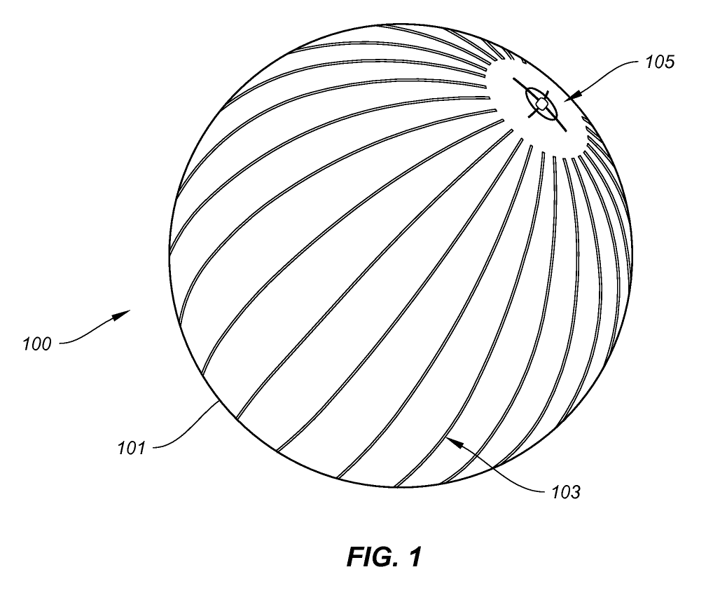

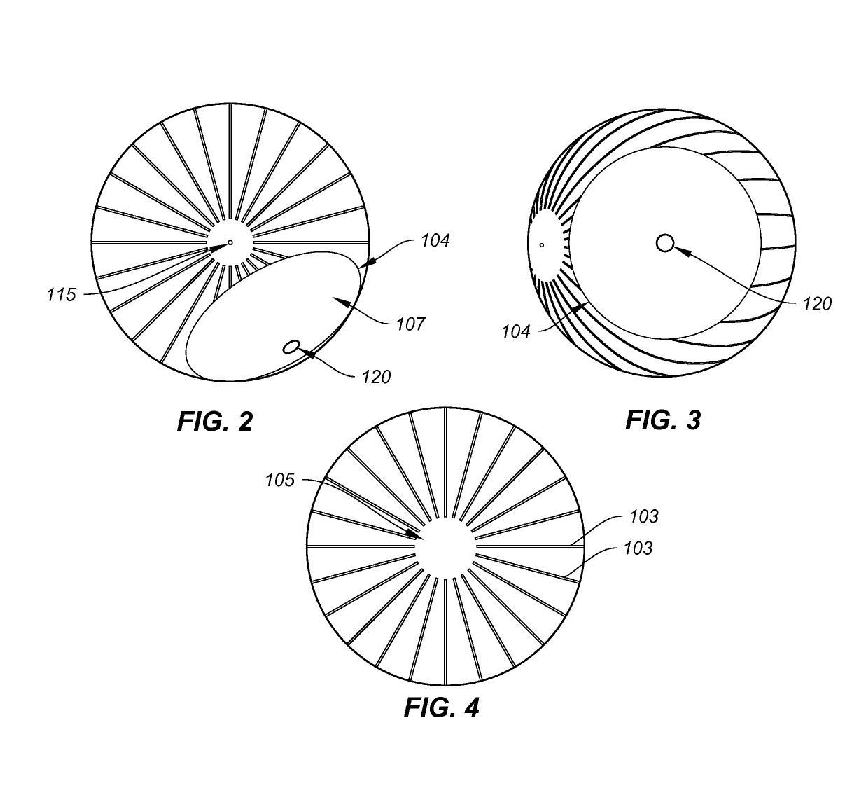

FIG. 1 is a perspective view of core fitness ball in accordance with an example embodiment; FIG. 2 is a profile view of the ball of FIG. 1 to show relative location of air fill and bung locations in more detail; FIG. 3 is a bottom view; and FIG. 4 a profile view of the ball of FIG. 1 to show location of a circular area on the ball to place graphics indicating where to place body position. Referring to FIGS. 1-4, and in general, the core fitness ball (hereafter “ball 100”) is an inflatable self-righting stability ball that may be constructed of a burst resistant material 101 such as a plastic, vinyl or similar material. In one example, the ball 100 may be sized for use based on the height of the individual using it, e.g., the taller the person, the larger the diameter of the ball. Three exemplary diameters may be 55 cm, 65 cm and 75 cm; of course other sizes are possible.

Ball 100 includes formed textured ribs 103 and a display area 105 thereon that provides a target or graphic to designate optimal body location position. The bottom or base (shown generally by arrow 107) includes a circular area 104 at which the textured ribs terminate (i.e., no ribs). The circular area 104 encompasses a weighted bung 120 that is inserted up within the interior thereof. FIG. 2 also shows the location of air valve 115.

Accordingly, due to the weighted bung 120, a feature of the ball 100 is an ability to self-right to the same position and ensure no roll away. The self-righting capability is accomplished through the use of bung 120. Bung 120 is inserted into the interior of the ball 100 during the manufacturing process.

As shown in FIGS. 2-4, the inclusion of a weighted bung 120 at the base 107 of the ball 100 combined with a body positioning designation system provided at display area 105 guides users to the perfect body positioning every time, whether performing crunches, squats, plank movements, etc. Ball 100 optionally may be provided with an air pump and instructional wall chart. This target or display area 105 for location and body positioning is significant as it takes the guess work out of where the exerciser should place their trunk for optimal return on effort.

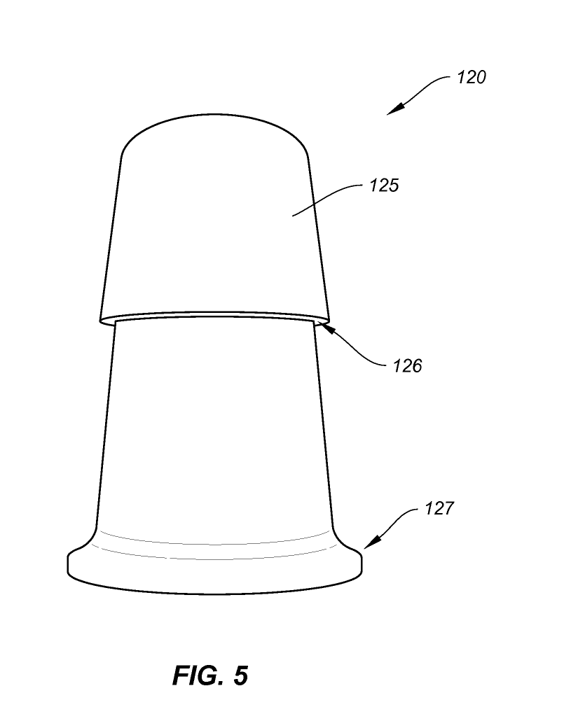

FIGS. 5-7 are provided to illustrate the bung 120 in more detail, and the position of the bung 120 within the ball 100 in more detail. Referring to FIG. 5, the weighted bung 120 includes a generally cylindrical barb 125 at an upper end. The barb 125 has essentially a mushroom shape. Bung 120 has a lower body part 129 extending downward from the barb 125. The lower body part 129 has a smaller diameter at its upper end than the barb 125. This forms a lip 126 between the barb 125 and lower body part 126, as shown in FIG. 5. The diameter of the lower body part 126 increases gradually toward the bottom of bung 120, terminating as a flared bottom end 127. The diameter of flared bottom end 127 is greater than the diameter of the barb 125.

In an example, the bung 120 may be coated in a vinyl or plastic to avoid corrosion and protect the floor surface, for example. As to be described hereafter, the lip 127 of the barb 125 is designed to interface or catch a ledge within an interior molded channel 110 within the ball 100 (not shown) as the bung is inserted within a lower opening of the ball 100, so that the bung 120 is not designed to be removed after insertion. This ledge creates a narrowed diameter opening. Upon insertion, the barb 125 is pushed through a narrowed opening at the base 107 of the ball 100 and contacts this ledge so as to fixedly secure the bung 120 within the interior channel 110. The narrowed opening prevents the larger barb 125 of the bung 120 from being pulled out of the interior channel 110 during use of the ball 100.

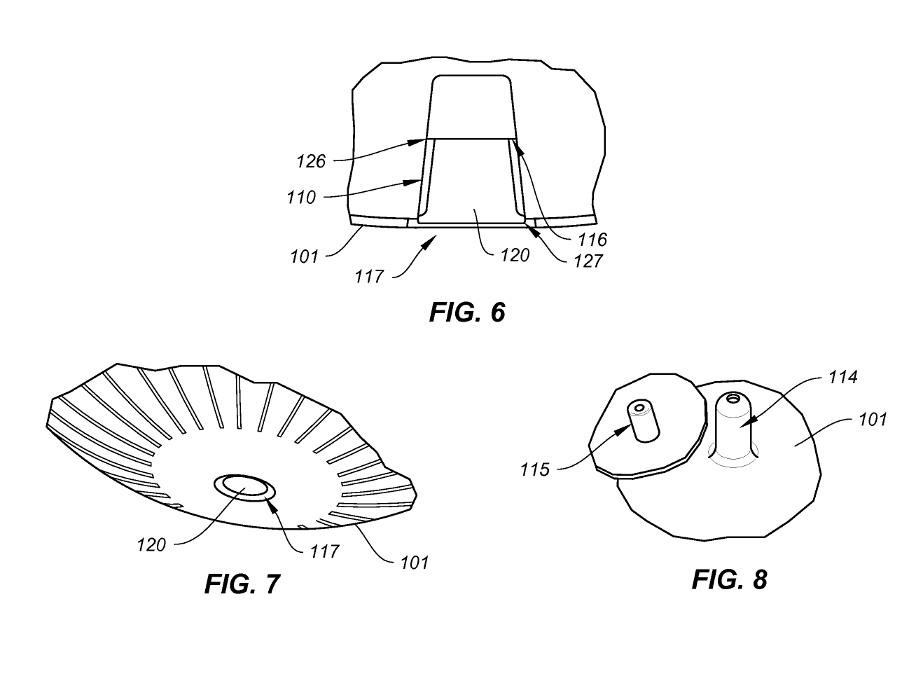

FIG. 6 best shows this structural interaction between lip and ledge. During the fabrication process, the bung 120 is inserted, via an opening 117 that is formed in the base 107 of the ball material 101, into the interior channel 110. This interior channel 110 is formed at time of manufacture. A ledge 116 is also formed in the interior channel 110.

As the bung is pushup up into the channel 110. The barb 125 passes the ledge 116 and the lip 126 of the barb 125 catches the ledge 116. The bottom flared end 127 sits flush with the bottom 107 of the ball 100 at opening 117, flush. Accordingly, once the bung 120 is fully inserted, as shown in FIGS. 6 and 7, it is not designed to be removed.

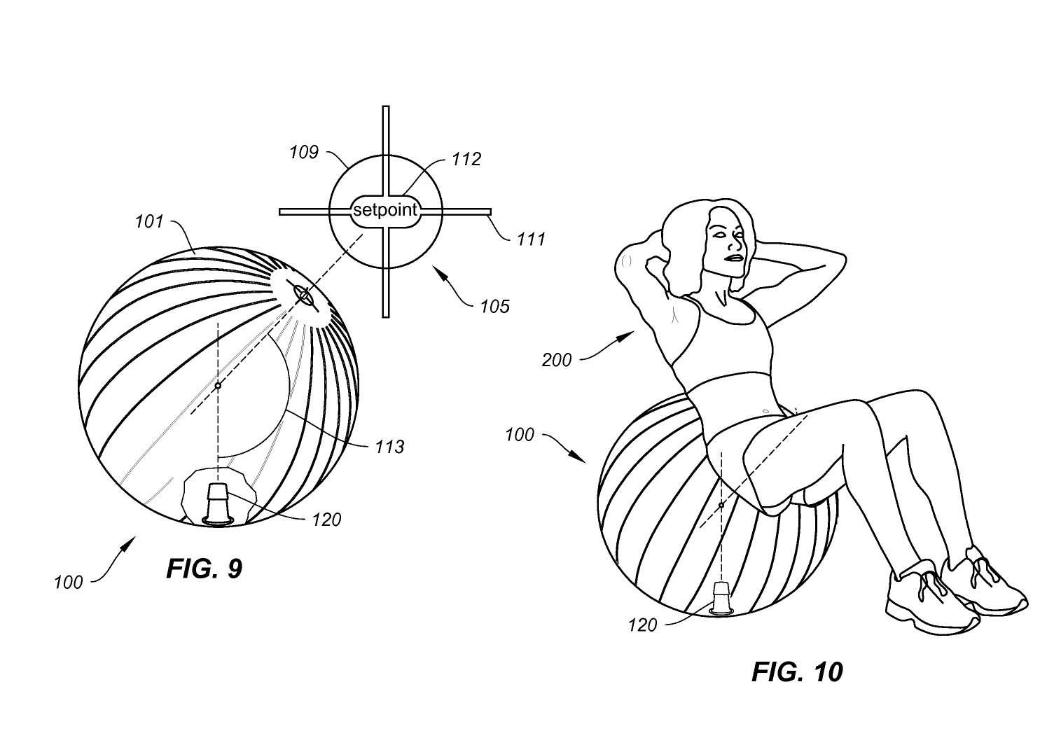

FIG. 8 is an example air fill channel with associated air valve in accordance with the example embodiments. Only a cutout portion of the ball 100 interior with the air fill channel 114 and fill valve 115 is shown for explanatory purposes only. The ball 100 includes an interior molded air fill valve channel 114 or collar that is part of the product design used to create the mold that forms this channel 114 in the material 101 of the ball 100. The air valve 115 may then inserted into the formed collar or channel 114 after removal of the formed ball 100 from the rotational molding machine.

FIG. 9 is a diagram to illustrate an example graphic for body positioning on the ball; and FIG. 10 illustrates a user positioning their body on the ball according to the graphic of FIG. 9. Referring to FIGS. 9 and 10, the material 101 of the ball includes a target or display area 105 for placement of a graphic 109 for designating optimal body positioning on the ball 100. The graphic 109 may include in one example a set of crosshairs 111 and written indicia (for example, it may state something like “setpoint” at 112). This identifies where the user 200 is to place their trunk, e.g., where to properly locate their body position on the ball 100. Accordingly, the location of the display area 105 with graphic 109 thereon provides a target to enable the exerciser to achieve repeated optimal body positioning on the ball 100, whether performing crunches, squats, plank movements, etc. The display area 105 with graphic 109 removes the guess work out of where the exerciser should place their trunk for optimal return on effort.

FIGS. 9 and 10 also illustrate the relative location of the bung 120 to the user 200 on ball 110. This relative angle 113 (about 120 degrees) does not change during exercise. In other words, the relative location or angle between the user 200 on the ball 100 and the bung 120 remains constant during exercise, with the user 200 positioned on the graphic 109 at display area 105 as shown in FIG. 10.

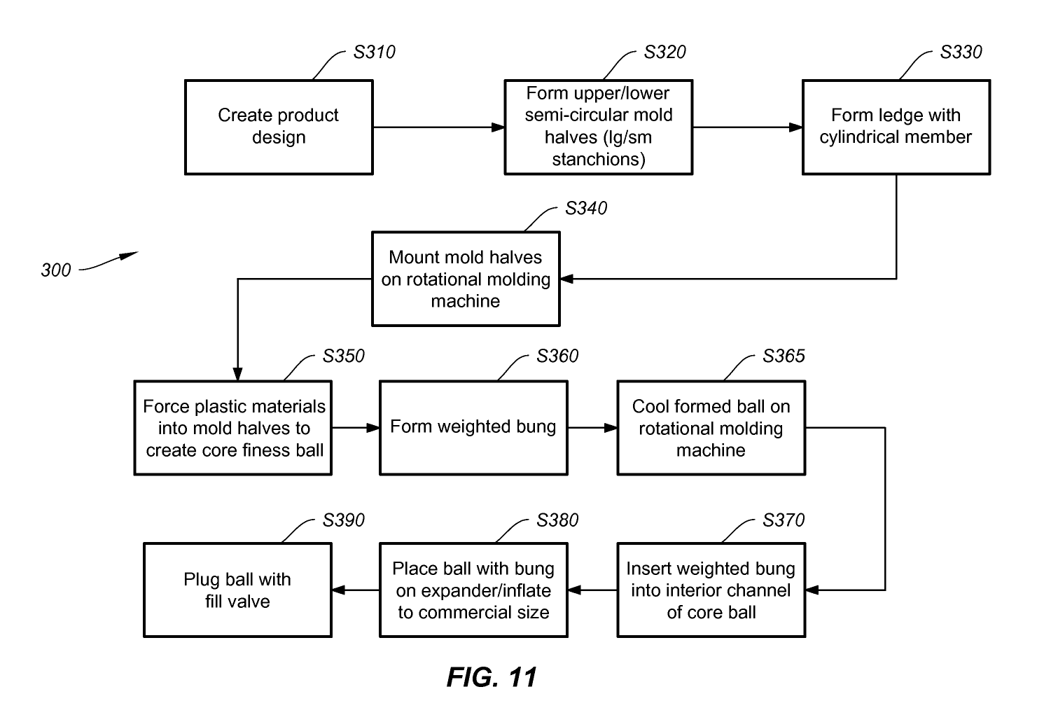

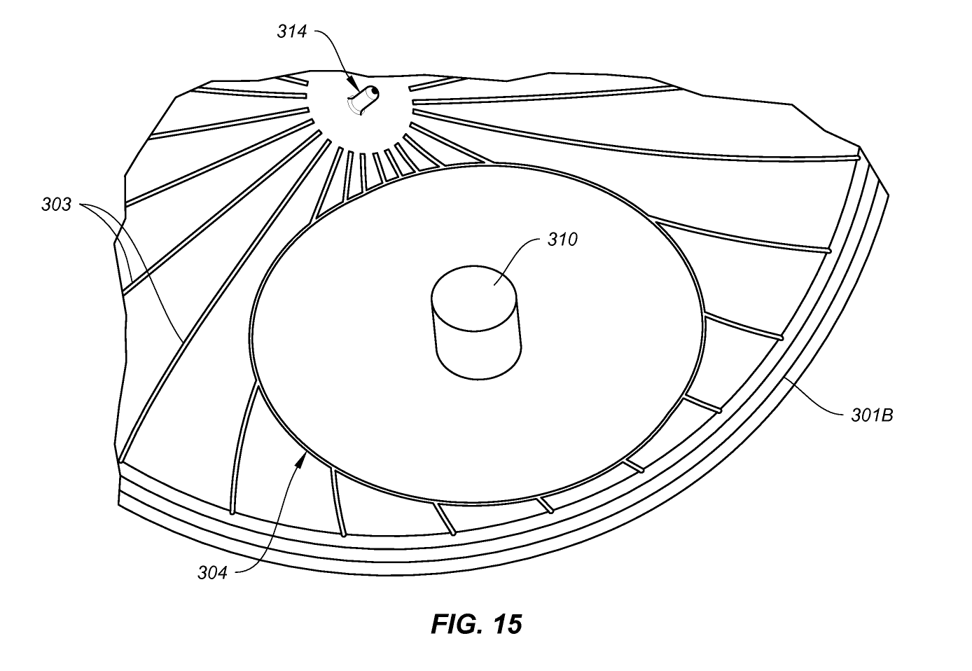

FIGS. 11-16 are provided to illustrate a method of fabricating an exercise ball with weighted base in accordance with an example embodiment. FIGS. 11-13 illustrate process flow charts, with FIGS. 14-16 showing cavity molds created from the product design for the self-righting core fitness ball in accordance with an example embodiment.

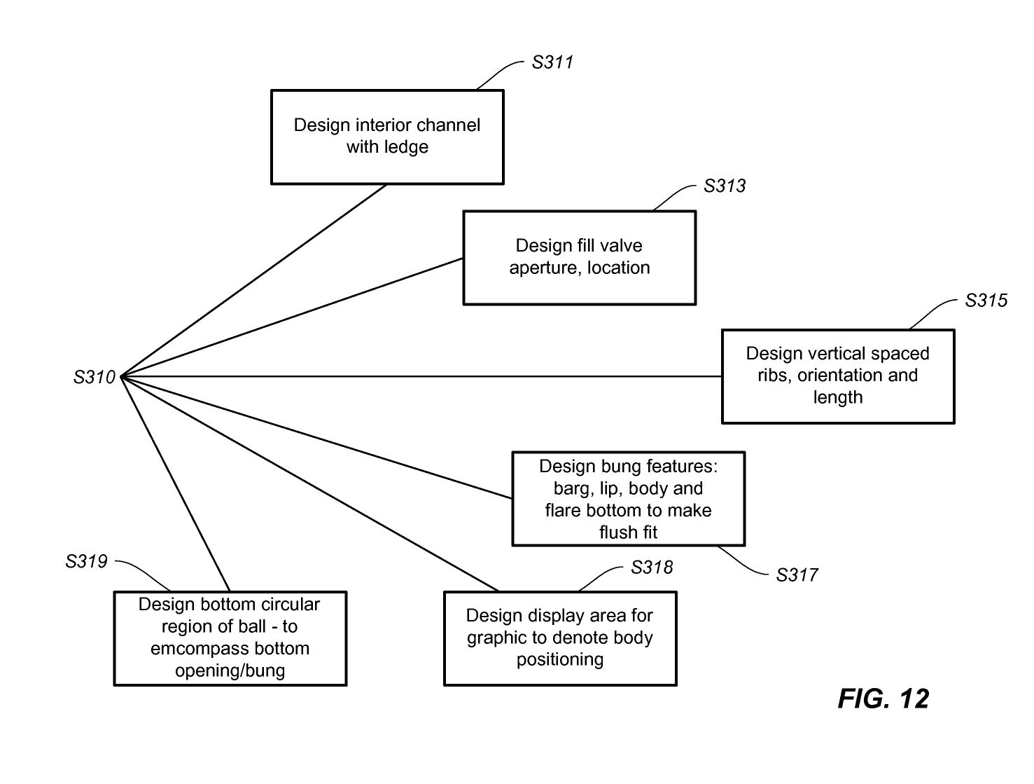

FIG. 11 is a flow diagram for illustrating a method of fabricating a self-righting core fitness ball according to an example embodiment. The method 300 includes creating a product ball design (S310) in software for a mold. As known, any CAD software design may be used to create the product design from which the mold or molds is to be formed. One example is SOLIDWORKS®. Creating the product design involves developing a number of specific design features in software from which machining centers create the mold. This may be further explained references FIG. 12.

FIG. 12 is a flow diagram illustrating process design steps in creating the product design according to the method of FIG. 11 in more detail. Creating the product design features for the ball may be done by the designer in no particular order, in software. As shown in FIG. 12, this may include: designing the interior channel 110 with the ledge 116 as shown in FIG. 6 (S311); designing the fill valve aperture and location in ball 100 (S313); designing the vertically spaces textured ribs 103 (S315); designing the features of the bung 120 as shown in FIG. 5 (S317), this is created in a separate mold or billet machining process separate from the ball; and designing the display area 105 for applying graphic 109 for body positioning (S318) and designing the bottom circular region 104 at base 107 which encompasses the bung 120 (S319). These design features are to be machined into the product cavities that form the mold(s).

Referring back to FIG. 11, upper and lower semi-circular mold halves are formed (S320) based on the created product design. Forming the lower mold half further includes (a) forming a larger metal stanchion protruding inward for creating the interior channel 110 in the to-be-formed ball 100 within the lower mold half, and (b) forming a smaller metal stanchion protruding inward and offset from the larger metal stanchion for creating an aperture (this is the air fill channel 114) for the fill valve 115 in the to-be-formed ball 100 within the lower mold half.

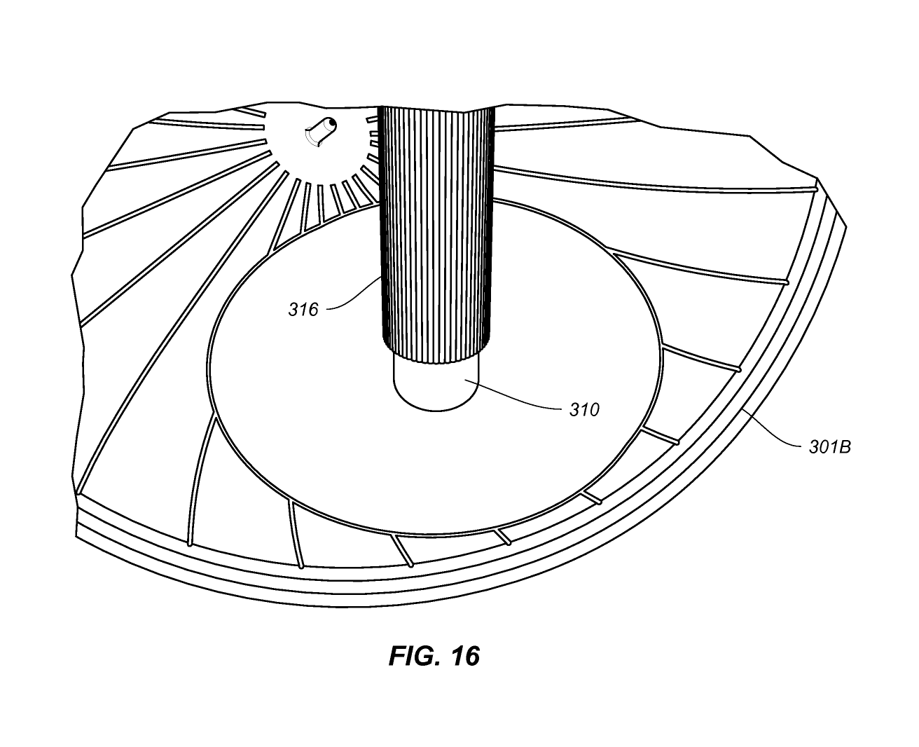

FIG. 14 illustrates the formed mold halves of the fabrication process; and FIG. 15 is a close-up view of the lower mold half used in the fabrication process to show design aspects of the ball in more detail. FIGS. 14 and 15 show the application of the product design to the molds in more detail; thus the product design is provided to create a mold containing one or more product cavities, here shown as two halves. FIG. 14 illustrates the upper mold half 301A and lower mold half 301B. The spaced textured rib mold lines 303 are shown in the molds for making ribs 103, as well as a bottom circular region circle mold line 304 for making the circular area 104, larger metal stanchion 310 for forming the interior channel 110, and smaller metal stanchion 314 for forming the air fill channel 114. The smaller circular mold line 305 for forming display area 105 is obscured in the upper mold half 301A of FIG. 14.

Referring back to FIG. 11, a cylindrical member is then placed over the formed larger stanchion (S330) in preparation for forming the ledge 116 within the interior channel 110. FIG. 16 is a close-up view of the lower mold half used in the fabrication process to show design aspects of the interior channel and ledge in more detail. A ribbed cylindrical member 316 is placed over larger stanchion 310 in the lower mold half 301B. During the rotational molding process, this will form the ledge 116 shown in FIG. 6.

Thereafter, the upper and lower mold halves 301A/B is mounted (S340) on a rotational molding machine, and plastic material is forced into the mold halves 301A/B (S350) to create the ball 100. The weighted bung 120 is formed (360) with its barb 125 at an upper end thereof, in a separate step.

The design and shape of bung may be done in CAD and formed using metal casting techniques. Alternately, bung 120 may be formed by heating a steel billet so as to form a bung 120. The bung 120 may be composed of an upper cylindrical barb 125 with a lower body part 129 extending downward from the barb 125, the lower body 129 part having a smaller diameter at its upper end than the barb 125 so that a lip 126 is formed between the barb 125 and lower body part, the diameter of the lower body part increasing gradually and terminating as a flared bottom end 127 with a diameter greater than the barb 125. After obtaining the desired shape through casting and/or heat treating and annealing techniques, the bung 120 is cooled, and a protective coating may be applied over the formed bung 120. For example, bung 120 may be coated or dipped in a similar vinyl material coating to protect it.

After the core fitness ball 100 is rotationally formed in the molds, it is subjected to cooling on the rotational molding machine (S365). The ball 100 has an opening 117 exposing the formed interior channel 110 with ledge 116 therein. The ball 100 cools down to a semi-cool state (still warm). The bung 170 is inserted partially into the interior channel 110 (S370) via the opening 117. Next, an expander machine is employed to inflate the ball 100 (S380) to its desired commercial size (such as 55 cm, 65 cm. 75 cm diameter, etc.). As this is done, the barb 125 catches the ledge 116 (via lip 126) to secure the bung 120 within the channel 110. Finally the fill valve 115 may be inserted into the fill valve channel 114 to plug the ball 100 (S390).

The ball 100 is stored in the inflated position for a period of time while the cooling is completed. The ball 100 is then deflated and packed for shipping.

The product design is provided to create a mold containing one or more product cavities, here shown as two halves. As shown in FIGS. 11 and 12, the ribs 103 and outer trim lines that define base 107, air fill valve 115 and display 105 are machined into the product cavities that form the mold. Moreover, in FIG. 12, the larger metal stanchion in the lower product cavity half represents the part that shall make the formed interior molded column channel 110 which receives the bung 120, and the smaller stanchion forms the opening for the air fill valve 115. Both thus are integral with the material 101 forming ball 100.

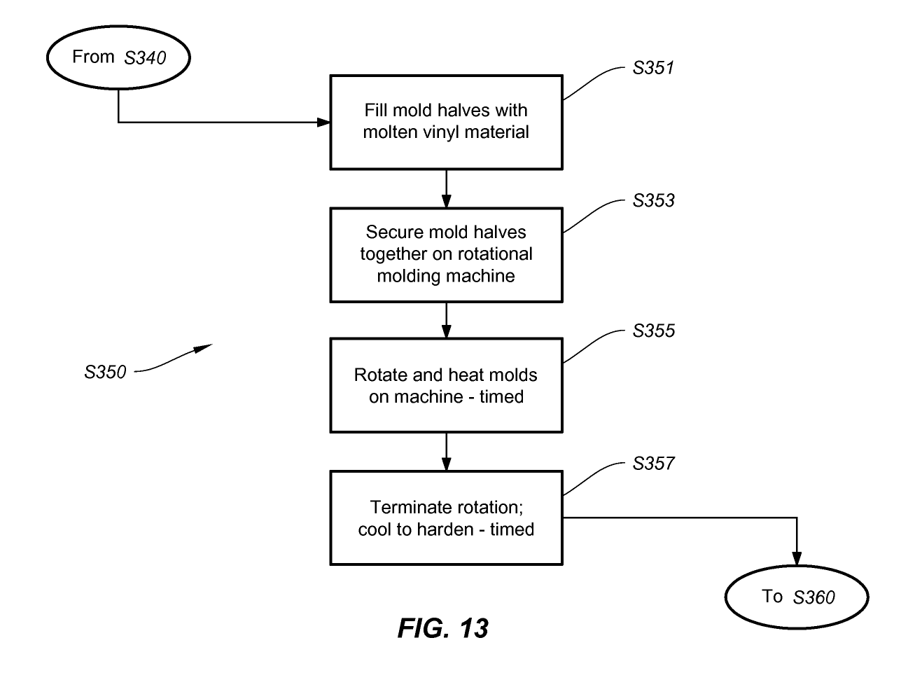

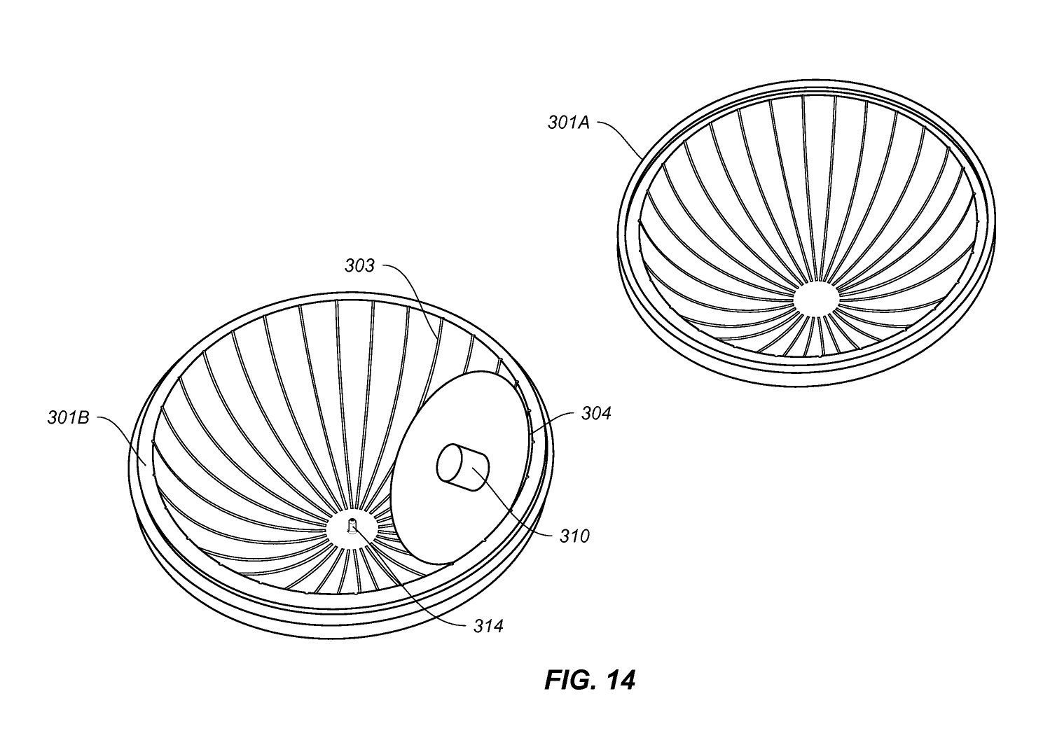

FIG. 13 is a flow diagram illustrating the forcing of plastic materials step of FIG. 11 in more detail. Process Step S350 involves a number of sub-processes) The molds 301A/B are arranged on a rotating molding machine and filled with a material (S351) that is used to create the ball 100. In an example, ball 100 may be formed of an expandable vinyl. In the molds, the ball 100, in an intermediate form are formed about the size of a soccer ball. The cavity halves are secured together (S353) on the machine with the materials inside, the machine is rotated with the molten material heated (S355) and coating the interior product cavities in total for a specified timing. Then the machine is stopped (rotation terminated), and the material cooled to a point S357 (and/or for a specified timing) so that the molten material begins to harden into the ball shape. The process then moves on to cooling at S360 and subsequent bung 120 insertion and inflation.

The example embodiments being thus described, it will be obvious that the same may be varied in many ways. Such variations are not to be regarded as departure from the example embodiments, and all such modifications as would be obvious to one skilled in the art are intended to be included within the following claims.

We claim:

1. A method of fabricating a self-righting core fitness ball, comprising:
creating a product ball design in software for a mold;
forming an upper semi-circular mold half and a lower semi-circular mold half based on the created product design, wherein forming the lower mold half includes forming a larger metal stanchion protruding inward for creating an interior channel in the to-be-formed ball within the lower mold half and forming a smaller metal stanchion protruding inward and offset from the larger metal stanchion for creating an aperture for a fill valve in the to-be-formed ball within the lower mold half,
placing a cylindrical member over the formed larger stanchion in preparation for forming a ledge within the interior channel,
mounting the upper and lower mold halves on a rotational molding machine,
forcing plastic material into the mold halves to form the ball, the ball having an opening exposing the interior channel with ledge therein,
forming a weighted bung, and
inserting the weighted bung into the interior channel via the opening.

2. The method of claim 1, wherein creating a product design further includes:
designing a plurality of vertically spaced texture ribs around an outer periphery of the product ball design,
designing a first circular area on an outer, upper surface of the product ball design for imprinting body positioning designation indicia thereon,
designing a second circular area in the product ball design which omits texture ribs, the second circular area designating the bottom of the ball and encompassing the weighted bung.

3. The method of claim 1, wherein forcing plastic material into the mold halves to create the ball further includes:
filling the mold halves with an expandable, molten vinyl material,
securing the mold halves together on the machine,
rotating the secured mold halves on the machine while heating the molten material for a period of time,
terminating rotation of the machine and cooling the molten material for a period of time until it hardens into a ball product.

4. The method of claim 1, wherein forming a weighted bung further includes:
heating a steel billet so as to form a bung composed of an upper cylindrical barb portion with a lower body part extending downward from the barb portion, the lower body part having a smaller diameter at its upper end than the barb portion so that a lip is formed between the barb portion and lower body part, the diameter of the lower body part increasing gradually and terminating as a flared bottom end with a diameter greater than the barb portion,
cooling the bung, and
applying a protective coating over the bung.

5. The method of claim 1, further comprising expanding the ball with weighted bung therein via inflation, the weighted bung having a barb at an upper end therein, expanding causing the barb to catch the ledge in the channel to prevent the bung from being removed once inserted.

6. The method of claim 5, further comprising, plugging the expanded ball with an air valve.

7. The method of claim 1, wherein
inserting the bung further includes partially inserting the bung into the opening, the bung having a barb at an upper end thereof, the method further comprising:
cooling the formed ball for a period of time,
expanding the ball with inserted bung therein so that the barb catches the ledge within the channel, and
plugging the ball with an air valve.

8. A core fitness ball, comprising:
an expandable, inflatable ball composed of burst-resistant material,
an opening provided in the ball,
the opening including an interior channel protruding inward into the ball interior, a weighted bung inserted into the interior channel via the opening, and,
a target on an outer, upper surface area thereof designating body positioning information for a user on the ball.

9. The ball of claim 8, wherein,
the interior channel includes a ledge formed therein, and
the bung includes a barb at an upper end thereof, the barb having a lip that engages the ledge as the bung is inserted into the channel to prevent the bung from being removed from the channel once inserted.

10. The ball of claim 8, further comprising:
a plurality of vertically spaced texture ribs around an outer periphery thereof.

11. The ball of claim 10, further comprising:
a circular area designating the bottom of the ball and encompassing the weighted bung, the spaced texture ribs terminating at a circumferential periphery of the circular area.

12. The ball of claim 8, wherein the relative location between a user on the ball and the bung remains constant during exercise as the user positions their trunk on the target.

13. The ball of claim 8, wherein the weighted bung includes a cylindrical barb at an upper end with a lower body part extending downward from the barb, the lower body part having a smaller diameter at its upper end than the barb so that the lip portion is formed between the barb and lower body part, the diameter of the lower body part increasing gradually and terminating as a flared bottom end of the bung with a diameter greater than the barb.

14. A core fitness ball formed by the method of claim 1.

15. A core fitness ball, comprising:
an expandable, inflatable ball,
an opening provided at a base of the ball contacting a surface,
a weighted bung inserted through the opening into the interior of the ball which is secured within upon insertion.

16. The ball of claim 15, further comprising:
a graphic imprinted on an outer surface thereof designating body positioning information, the relative location between a user on the ball and the bung remaining constant during exercise with the trunk of the user positioned on the graphic.

17. The ball of claim 15, wherein
the weighted bung includes a cylindrical barb at an upper end with a lower body part extending downward from the barb, the lower body part having a smaller diameter at its upper end than the barb so that a lip is formed between the barb and lower body part, the diameter of the lower body part increasing gradually and terminating as a flared bottom end of the bung with a diameter greater than the barb, and
an interior channel is formed within the ball for receiving the bung via the opening, the interior channel including a ledge that catches the lip of the bar to prevent the bung from being removed therefrom once inserted.

18. A core fitness ball, comprising:
an inflatable ball,
a metal bung within the interior of the ball, and
a target on an outer surface thereof designating body positioning information for the user.

19. The ball of claim 18, wherein a relative angle between a user on the ball and the bung is constant during exercise with the trunk of the user positioned on the target.
